(19) United States
(12) Patent Application Publication
(10) Pub. No.: US 2003/0149586 A1
(43) Pub. Date: Aug. 7, 2003

(54) Method and system for root cause analysis of structured and unstructured data

(75) Inventors: Michael H. Chen, Redwood City, CA (US); Ronald Hildebrandt, San Francisco, CA (US); Stan N. Stukov, Hillsborough, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ENKATA Technologies, San Mateo, CA (US)

(21) Appl. No.: 10/291,236

(22) Filed: Nov. 7, 2002

Related U.S. Application Data
(60) Provisional application No. 60/337,356, filed on Nov. 7, 2001.

(51) Int. Cl. G06F 17/60

(52) U.S. Cl. 705/1; 705/400

(57) ABSTRACT

An improved method (and system) of processing information for root cause analysis. The method includes inputting structured data in a first format and unstructured data from a real process from a service or manufacturing operation, e.g., call center for customer support, customer information systems for marketing, or product information systems for supply-chain. The method converts the unstructured information into a second structured format (optional). In some embodiments, there may not be any unstructured data. The method combines the structured data in first format and structured data in second format. The method then stores the structured data in the first format and the structured data in the second format into memory. A step of processing the combined data with one or more business processes (e.g., customer life cycle, a company organization, or problem-fix type) to couple the business process with the structured and unstructured data is included. The method processes information from the combined data with one or more financial models (e.g., revenue model, a cost model) to couple the financial models with the structured and unstructured data. One or more factors are identified from the real process. Such factors include a symptom, an indicator, and other descriptions of an improvement opportunity. The method determines one or more aggregate patterns coupled to the identified factors from the processed data. The method couples one of the patterns an economic value; and displays the factor and the pattern related to the factor and the economic value.

### CROSS-REFERENCES TO RELATED APPLICATIONS

This application claims priority to U.S. Provisional Patent Application Ser. No. 60/337,356 (Attorney Docket No. 021269-000100US) filed Nov. 7, 2001 and titled “METHOD AND SYSTEM FOR ROOT CAUSE ANALYSIS OF STRUCTURED AND UNSTRUCTURED DATA” in the name of Michael H. Chen, commonly assigned, and incorporated herein.

### BACKGROUND OF THE INVENTION

The present invention relates generally to improving operations through data analysis. More particularly, the invention provides a method and system for processing structured and unstructured data derived from a real process and relating such data to an economic value for improving such process. Merely by way of example, the invention is applied to processing data from a call center of a large wireless telecommunication service provider. But it would be recognized that the invention has a much wider range of applicability. For example, the invention can be applied to other real operations, including services or manufacturing, such as financial services, insurance services, high technology, retail, consumer products, and the like.

Common goals of almost every business are to improve profits and operations. Profits are generally derived from revenues less costs. Operations include manufacturing, service, and other features of the business. Companies have spent considerable time and effort to control costs to improve profits and operations. Many such companies rely upon feedback from a customer or detailed analysis of company finances and/or operations. Most particularly, companies collect all types of information in the form of data. Such information includes customer feedback, financial data, reliability information, product performance data, employee performance data, and customer data.

With the proliferation of computers and databases, companies have seen an explosion in the amount of information collected. Using telephone call centers as an example, there are literally over one hundred million customer calls received each day in the United States. Such calls are often categorized and then stored for analysis. Unfortunately, conventional techniques for analyzing such information are often time consuming and not efficient. That is, such techniques are often manual and require much effort.

Accordingly, companies are often unable to identify certain business improvement opportunities. Much of the raw data including voice and free-form text data are in unstructured form thereby rendering the data almost unusable to traditional analytical software tools. Moreover, companies must often manually build and apply relevancy scoring models to identify improvement opportunities and associate raw data with financial models of the business to quantify size of these opportunities. An identification of granular improvement opportunities would often require the identification of complex multi-dimensional patterns in the raw data that is difficult to do manually. In addition to these limitations, there are many others.

From the above, it is seen that an improved way of improving a real process using data analysis is highly desirable.

### BRIEF SUMMARY OF THE INVENTION

According to the present invention, techniques for improving operations through data analysis are provided. More particularly, the invention provides a method and system for processing structured and unstructured data derived from a real process and relating such data to an economic value for improving such process. Merely by way of example, the invention is applied to processing data from a call center of a large wireless telecommunication service provider. But it would be recognized that the invention has a much wider range of applicability. For example, the invention can be applied to other real operations, including services or manufacturing, such as financial services, insurance services, high technology, retail, and consumer products.

In a specific embodiment, the present invention provides an improved method of processing information for root cause analysis. The method includes inputting in a first format, structured data and/or unstructured data e.g., textual comments/notes and voice recordings from a real process from a service or manufacturing operation, e.g., call center for customer support, customer information systems for marketing, or product information systems for supply-chain. The method converts the unstructured information into a second structured format (optional). In some embodiments, there may not be any unstructured data. The method combines the structured data in first format and structured data in second format. The method then stores the structured data in the first format and the structured data in the second format into memory. A step of processing the combined data with one or more business processes (e.g., customer life cycle, a company organization, or problem fix-type) to couple the business process with the structured and unstructured data is included. The method processes information from the combined data with one or more financial models (e.g., revenue model, a cost model) to couple the financial models with the structured and unstructured data. The method applies one or more relevancy scoring models to identify factors from the real process. Such factors include a symptom, an indicator, and other descriptors of an improvement opportunity. The method determines one or more aggregate patterns coupled to the identified factors from the processed data. The method couples one of the patterns to an economic value; and displays the factor and the pattern related to the factor and the economic value.

In an alternative embodiment, the invention provides a system including one or more memories. The memories include computer codes. A code is directed to receiving structured data in a first format and unstructured data in a first format from a real process from a service or manufacturing operation. A code is directed to convert the unstructured data in the first format into a second structured format. The one or more memories also include a code directed to collect the structured data in first format and structured data in second format; and a code directed to store the structured data in the first format and the structured data in the second format into memory. One or more codes are directed to process information from collected data with one or more business processes to couple the business process with the structured and unstructured data. One or more codes are directed to process information from the collected data with one or more financial models to couple the financial models with the structured and unstructured data. A code is directed to identify one or more factors derived from the real process; and a code directed to determine one or more aggregate patterns coupled to the identified factors from the processed data. A code directed to couple one of the patterns to an economic value; and a code directed to displaying the factor and the pattern related to the factor and the economic value. Depending upon the embodiment, there can be other computer codes to carry out the functionality described herein.

Many benefits are achieved by way of the present invention over conventional techniques. The present invention can be implemented using conventional hardware and/or software technologies. The invention can also be used to improve a real process from a service or manufacturing operation. Preferably, the invention can provide a user of the method and/or system with insight into economic improvement with simple user interfaces at a “click” of a user interface. In some embodiments, the invention can provide methods and systems that identify, fix, and maintain root cause problems that drive costs, such as operational costs and the like. In some embodiments, the invention can provide methods and systems that identify opportunities to increase revenues and/or margins. Additionally, the invention can be used to quantify economic value of an improvement opportunity. The invention can also be used to track the success of initiatives launched as a result of the insights to improve a real process. Depending upon the embodiment, one or more of these benefits may be achieved. These and other benefits will be described in more detail throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a system according to an embodiment of the present invention;

FIG. 1A is a simplified diagram of an alternative system according to an embodiment of the present invention;

FIG. 1B is a slightly more complex representation of a system according to an embodiment of the present invention;

FIG. 2 is a more detailed diagram of a system according to an embodiment of the present invention;

FIG. 2A is a more detailed diagram of a system according to an embodiment of the present invention.

FIG. 2B describes main components of the analytical reporting components of the system according to an embodiment of the present invention;

FIGS. 2C and 2C1 describe structures of Taxonomy according to embodiments of the present invention;

FIG. 2D describes a Taxonomy Training Set Generation Process according to an embodiment of the present invention;

FIG. 2E is a user interface of an application enabling taxonomy maintenance process according to an embodiment of the present invention;

FIG. 3 is a detailed hardware diagram of the system of FIG. 2 according to an embodiment of the present invention;

FIG. 3A is an overall hardware diagram of a system according to an embodiment of the present invention;

FIG. 4 is a detailed diagram of system software according to an embodiment of the present invention;

FIG. 4A is a detailed system diagram according to an alternative embodiment of the present invention;

FIGS. 5 and 6 are simplified flow diagrams of methods according to embodiments of the present invention;

FIGS. 7 through 10, 10A, and 10B are simplified diagrams illustrating methods according to embodiments of the present invention;

FIG. 11 is a simplified diagram of an activities tracking system according to an embodiment of the present invention;

FIG. 12 is a more detailed diagram of an activities tracking system according to an embodiment of the present invention;

FIG. 13 are examples of templates according to embodiments of the present invention;

FIG. 14 is a detailed diagram of a data load process according to an embodiment of the present invention;

FIG. 14A is a more detailed diagram of a staging and transform process according to an embodiment of the present invention;

FIG. 15 is a simplified diagram of a block sequencing process according to an embodiment of the present invention;

FIG. 16 is a simplified diagram of a block execution process according to an embodiment of the present invention; and

FIG. 17 is a simplified diagram of a parallel block execution process according to an embodiment of the present invention.

### DETAILED DESCRIPTION OF THE INVENTION

According to the present invention, techniques for improving operations through data analysis are provided. More particularly, the invention provides a method and system for processing structured and unstructured data derived from a real process and relating such data to an economic value for improving such process. Merely by way of example, the invention is applied to processing data from a call center of a large wireless telecommunication service provider. But it would be recognized that the invention has a much wider range of applicability. For example, the invention can be applied to other real operations, including services or manufacturing, such as financial services, insurance services, high technology, retail, and consumer products.

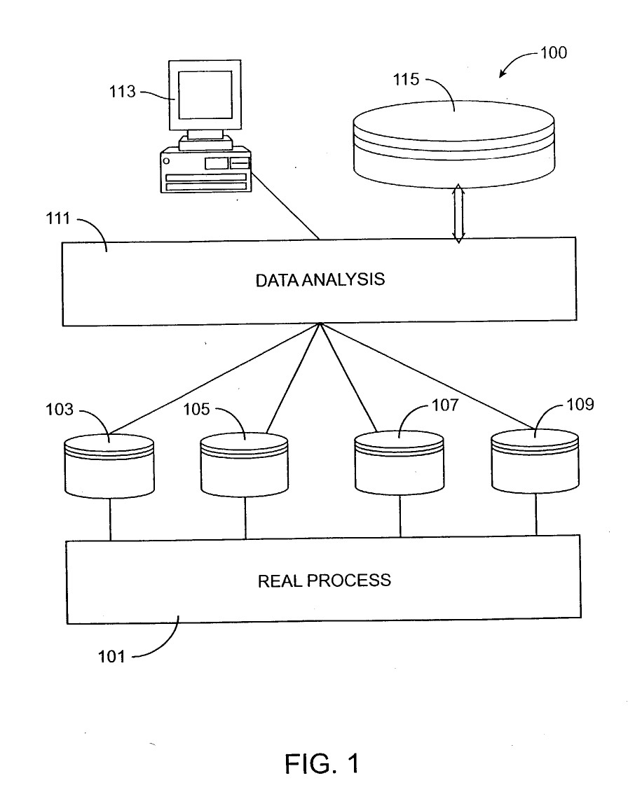

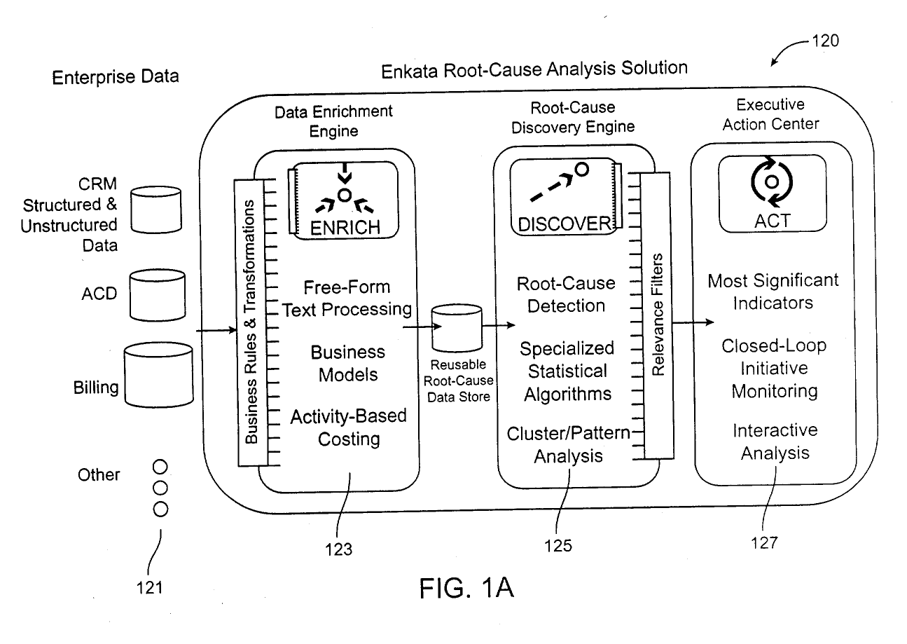

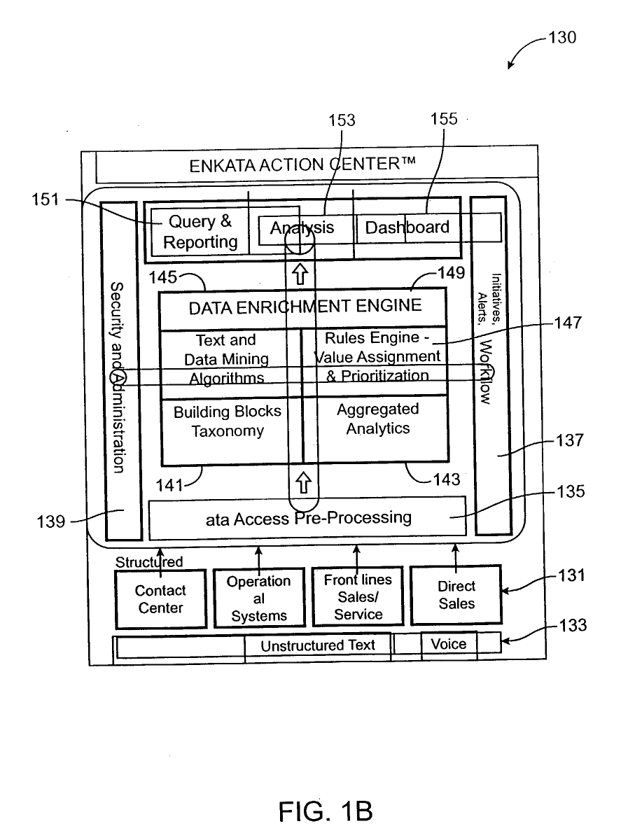

FIG. 1 is a simplified diagram of a system 100 according to an embodiment of the present invention. This diagram is merely an example and should not unduly limit the scope of the claims herein. One of ordinary skill in the art would recognize many other variations, modifications, and alternatives. As shown, the system includes a real process 101, which can be a portion of a service or manufacturing operation. The real process can include telephone call center service processes, sales and marketing processes, manufacturing processes, and any other processes required to support a business. The real process often has information that is derived from the process directly or indirectly. The real processes often include structured and unstructured information, which are difficult to filter and/or understand. The information is often stored in databases 103, 105, 107, and 109. Such databases can include relational databases such as those made by Oracle Corporation of Redwood City, Calif. or Microsoft Corporation, Redmond, Wash.. As shown, there are multiple databases or files. Alternatively there can also be a single database or file. The databases and/or files can be arranged in a manner where the data is structured or unstructured.

As merely an example, structured data can appear as follows:

| RECORD | | | REASON | MINUTES | | |
|---|---|---|---|---|---|---|
| ID | PRODUCT | CUSTOMER | CODE | ON CALL | . . . | SOURCE |
| 1 | Nokia 5160 | 13592 | 01— | 15 | . . . | Western |
| | | | Billing | | | Region |

As shown above, the structured data is categorized by fields, etc.

Unstructured data can also be included. As merely an example, unstructured data can appear as follows (which are shown in italics for easy reading):

“Customer called because the new text messaging feature does not work and neither does his voicemail. He has a Nokia 5160 phone.”

This message typically contains typos and abbreviations. For example, an unstructured data above could be recorded as: “Cust called the new txt msg featre and v-mail not work. Nokia 5160.”

As shown above, the unstructured data does not have any particular form or organization and are often in sentences or part of sentences, etc. The unstructured data are literally unstructured. Such data could be voice recordings or the like according to specific embodiments.

The databases feed into a data analysis engine 111. According to a specific embodiment, the data feed could be direct or through an export file or any combination of these, and the like. The data analysis engine receives data including structured and unstructured and uncovers patterns, which are used to identify areas of improvement in the process. Further details of the data analysis engine are provided throughout the present specification and more particularly below. A client device 113 is coupled to the data analysis engine 111. A database 115 for storing the patterns is also coupled to the data analysis engine 111. Preferably, the data analysis engine is implemented in software form but can also be a combination of hardware and software. The client device can be a computer system, such as the one provided below.

FIG. 1A is a simplified diagram of an alternative system 120 according to an embodiment of the present invention. As shown, the system extracts information from the operational systems as well as Data marts/Data warehouses 121, enriches 123 this information by processing unstructured text and voice 125, populates the present database and presents analytical reports summarizing cost improvement and revenue generation opportunities to the user 127. As shown, the information includes pre-sales (which has voice, text, and structured data), sales (which includes text and voice, and structured data), post sales (which includes structured, text, and voice), relationship (which includes structured, text, and voice), and research (which also includes structured, text, and voice), among others (not shown). In addition to this, the present embodiment of the system implements Alerts, Initiatives 127 and uses workflow to track the impact of the initiatives. The user access to the system is controlled by security module that restricts access to the application functionality and viewing analytical reports. Further details of the present system are provided throughout the present specification and more particularly below.

FIG. 1B is a slightly more complex representation of a system 130 according to an embodiment of the present invention. This diagram is merely an example, which should not unduly limit the scope of the claims herein. One of ordinary skill in the art would recognize many other variations, alternatives, and modifications. Data are derived from 131, contact center, operational systems, front line sales/service, direct sales, financial, and other sources. Such data includes structured, unstructured, voice 133, and possibly others. As shown, the system includes: Data Load (including Cleanup and Transformation) 135, Data Enrichment 149 (including Taxonomy Creation 141, Text, Voice and Structured Data processing 145 as well as applying Financial Models 143 147 to the data), Query and Analysis Tools 151, 153 as well as the Administration and Security Tools 139. It also shows Initiatives, Alerts and Workflow parts 137 of the system. A work flow 137 module is coupled to the data load, enrichment engine, and output modules, 151, 153, and 155. Depending upon the embodiment, there can be other modifications, alternatives, and variations.

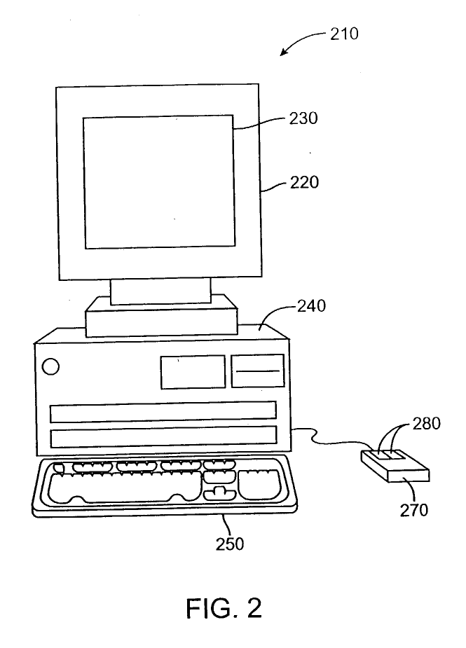

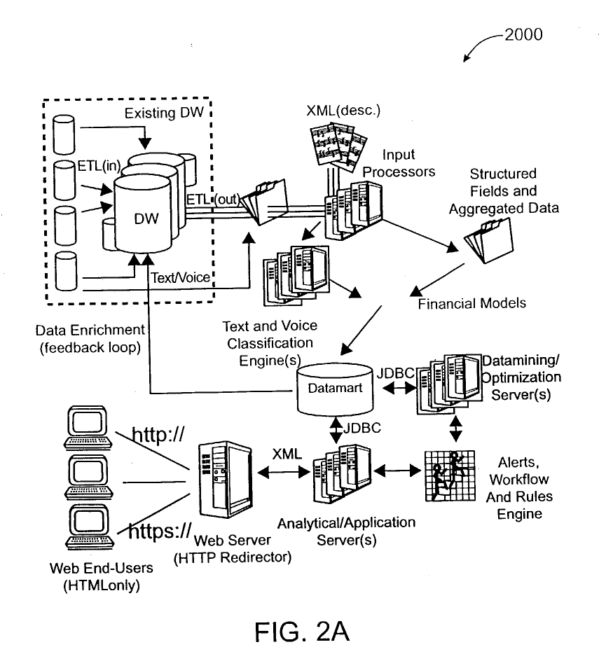

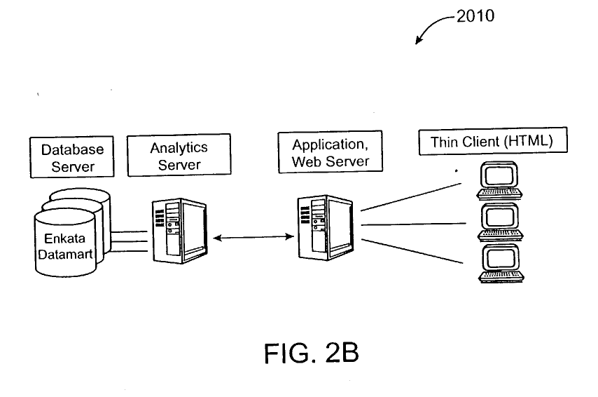

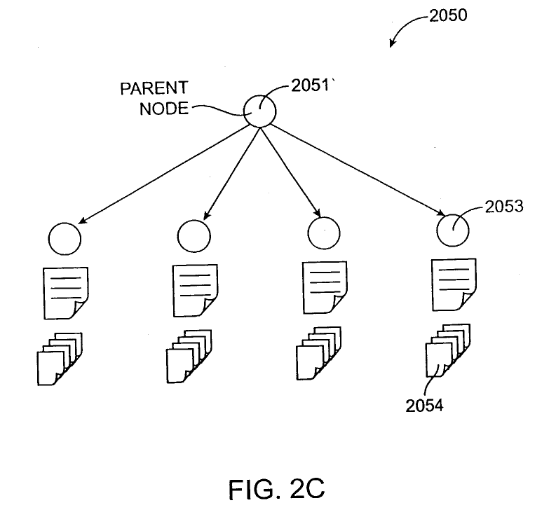

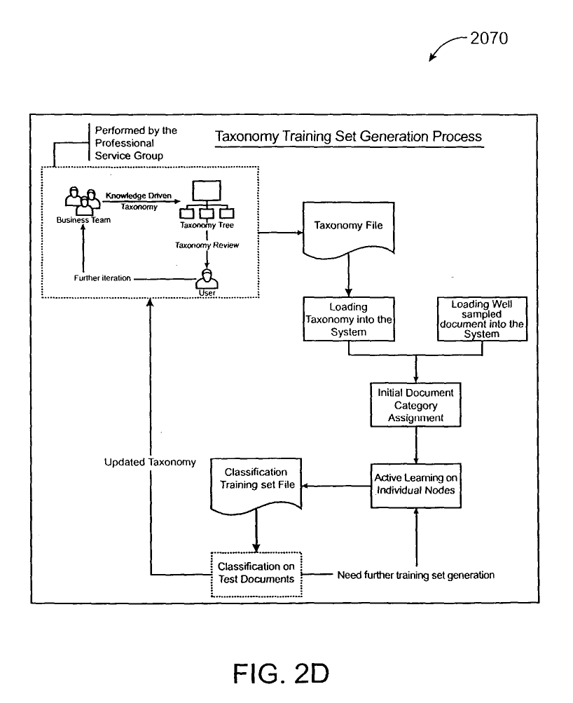

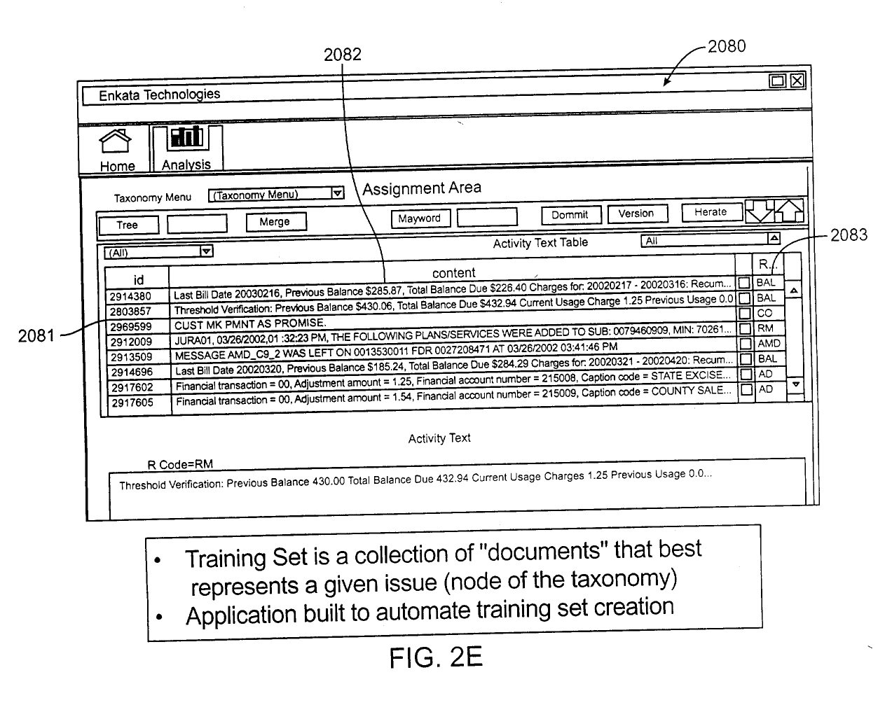

Referring to FIG. 2, a computer system 210 for implementing the present method is provided. This system is merely an example, which should not unduly limit the scope of the claims herein. One of ordinary skill in the art would recognize many variations, alternatives, and modifications. Embodiments according to the present invention can be implemented in a single application program such as a browser, or can be implemented as multiple programs in a distributed computing environment, such as a workstation, personal computer or a remote terminal in a client server relationship. FIG. 2 shows computer system 210 including display device 220, display screen 230, cabinet 240, keyboard 250, scanner and mouse 270. Mouse 270 and keyboard 250 are representative “user input devices.” Mouse 270 includes buttons 280 for selection of buttons on a graphical user interface device. Other examples of user input devices are a touch screen, light pen, track ball, data glove, microphone, and so forth. FIG. 2 is representative of but one type of system for embodying the present invention. It will be readily apparent to one of ordinary skill in the art that many system types and configurations are suitable for use in conjunction with the present invention. In a preferred embodiment, computer system 210 includes a Pentium™ class based computer by Intel Corporation, running Windows™ operating system by Microsoft Corporation, but can also be others depending upon the application. However, the apparatus is easily adapted to other operating systems and architectures by those of ordinary skill in the art without departing from the scope of the present invention.

As noted, mouse 270 can have one or more buttons such as buttons 280. Cabinet 240 houses familiar computer components such as disk drives, a processor, storage device, etc. Storage devices include, but are not limited to, disk drives, magnetic tape, solid state memory, bubble memory, etc. Cabinet 240 can include additional hardware such as input/output (I/O) interface cards for connecting computer system 210 to external devices external storage, other computers or additional peripherals, which are further described below.

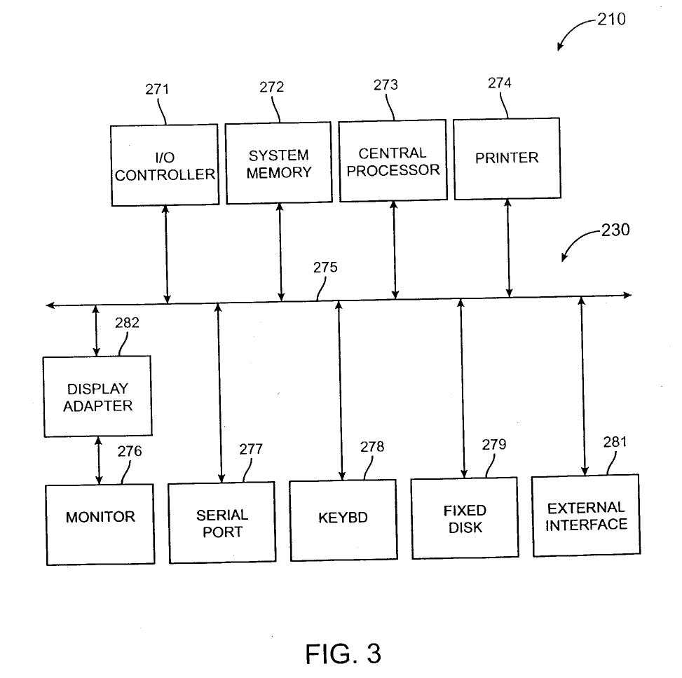

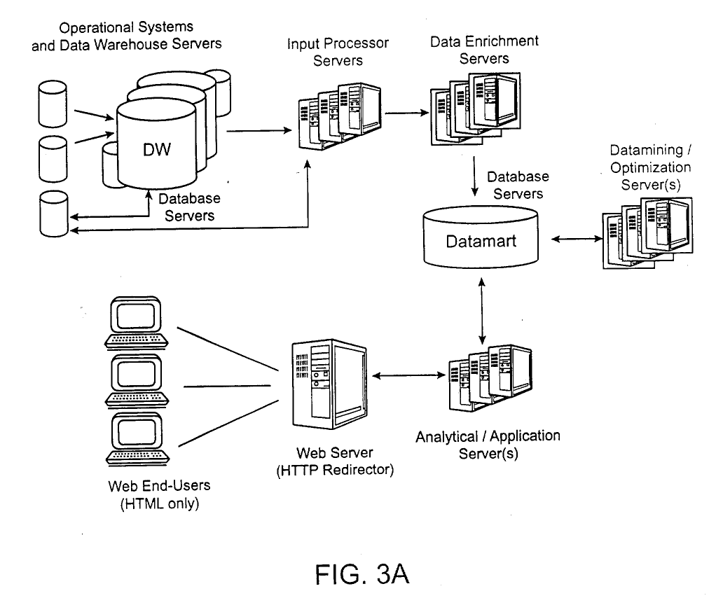

FIG. 3 is an illustration of basic hardware subsystems in computer system 210 of FIG. 2. This diagram is merely an illustration and should not limit the scope of the claims herein. One of ordinary skill in the art will recognize other variations, modifications, and alternatives. In certain embodiments, the subsystems are interconnected via a system bus 275. Additional subsystems such as a printer 274, keyboard 278, fixed disk 279, monitor 276, which is coupled to display adapter 282, and others are shown. Peripherals and input/output (I/O) devices, which couple to I/O controller 271, can be connected to the computer system by any number of means known in the art, such as serial port 277. For example, serial port 277 can be used to connect the computer system to a modem 281, which in turn connects to a wide area network such as the Internet, a mouse input device, or a scanner. The interconnection via system bus allows central processor 273 to communicate with each subsystem and to control the execution of instructions from system memory 272 or the fixed disk 279, as well as the exchange of information between subsystems. Other arrangements of subsystems and interconnections are readily achievable by those of ordinary skill in the art. System memory, and the fixed disk are examples of tangible media for storage of computer programs, other types of tangible media include floppy disks, removable hard disks, optical storage media such as CD-ROMs and bar codes, and semiconductor memories such as flash memory, read-only-memories (ROM), and battery backed memory. Embodiments of methods that can be implemented using the present system are provided in more detail below. Depending upon the embodiment, the present invention can be implemented, at least in part, using such computer system. As merely an example, the computer system can be implemented in an overall network system which will be described in more detail below.

FIG. 2A is a more detailed diagram of a system 2000 according to an embodiment of the present invention. This diagram is merely an example, which should not unduly limit the scope of the claims herein. One of ordinary skill in the art would recognize many other variations, alternatives, and modifications. As shown, the system includes data flow and major components of the system according to a specific embodiment. The information processed by the embodiment of the present invention is extracted from the customer systems in a form of the text files or via commercially available Export-Transform-Load (ETL) tools such as produced by companies called Informatica (Power Mart and Power Center), Ascential (Data Stage and Meta Recon), Embarcadero (DT/Studio), XML Global (XML Transform) or other similar tools. The XML technology is used to describe the structure of the exported information and how to transform and clean-up this information for input into the present invention. The Input Processor program accepts customer information and, using XML description, cleans and transforms and splits it into structured and unstructured parts. Alternatively, other common formats that do not include XML can be used according to other embodiments. The structured part represents the database fields collected by customer's operational systems. The unstructured part represents Free-form Text and Voice. The Text and Voice are processed by the Classification Engines and mapped to the Business Taxonomy.

The Structured Information and Post-processed Text/Voice are merged together with one or more financial models. A one or more Relevancy Scoring models is applied to the data. The Financial models describe the costs/revenue associated with the data and allocate these financials to certain and/or all parts of the system enabling the user of the invention to determine financial implications of the Initiatives. The post-processed and enriched with financials information data is stored in present Datamart for analytical reporting. The present embodiment of the invention incorporates a scheduler program that monitors for incoming files. It ensures that new files are processed as scheduled and provides customers with all the flexibility they need on how often they want to import files.

The Data Mining Server accesses the Datamart and computes aggregate information used in the Analytical reporting. These statistics are stored as the additional tables in a Datamart.

FIG. 2B describes main components of the analytical reporting components of the system 2010 according to an embodiment of the present invention. This diagram is merely an example, which should not unduly limit the scope of the claims herein. One of ordinary skill in the art would recognize many other variations, alternatives, and modifications. Here, an analytics server accesses customized database (e.g., Enkata Datamart Database Schema), extracts the information and passes it to the Application Server that formats the data and serves HTML via the WEB Server to the browser-based desktops.

In the present embodiment of the invention, Taxonomies and Training Sets enable the Classification Engines to process the unstructured information.

FIGS. 2C (and 2C1) describes the structure 2050 of Taxonomy according to an embodiment of the present invention. This diagram is merely an example, which should not unduly limit the scope of the claims herein. One of ordinary skill in the art would recognize many other variations, alternatives, and modifications. Taxonomy 2050 represents a hierarchy of Symptoms and Indicators associated with the customer record. Symptoms represent the reasons for calls while Indicators represent the context surrounding the call.

In the present embodiment of the invention, the Text Classification Engine is based on Statistical Algorithms and Assumes presence of the Business Taxonomy and the Training Set associated with the nodes of the taxonomy. The Classification Engine associates each customer interaction record with one or many nodes of Business Taxonomy and assigns statistical confidence to this association.

The present taxonomy is created by interviewing customers and combining this information with the information found in the free form text. The present invention includes User Interface Tools to ease Taxonomy Development process.

As shown, the diagram includes a parent node 2051, which has a plurality of nodes 2051. Each node 2051 of taxonomy used for Text classification is associated with a set of records 2054 also known as a Training Set. [A training set represents a set of text records used as representative text examples for each taxonomy node. An algorithm produces set of statistics for each category based on statistical information (ex. words frequencies) produced by analyzing training records for each taxonomy category. An algorithm then compares each incoming text record (statistics derived from it) with the set of records in the training (statistics of the training set) set for a given category and produces a similarity number/probability indicating the likelihood that incoming text record contains information represented by the taxonomy node. To reduce the effort of creating a training set, the invention includes a Graphical User Interface and the system of assigning the “positive” and “negative” examples of the records to the taxonomy categories (“Active Learning”). Positive examples are representative of the text records that should be classified to a given taxonomy category. Negative examples are representative of the text records that should not be classified to a given taxonomy category. Of course, one of ordinary skill in the art would recognize many other variations, modifications, and alternatives.

FIG. 2D describes Taxonomy Training Set Generation Process 2070 according to an embodiment of the present invention. This diagram is merely an example, which should not unduly limit the scope of the claims herein. One of ordinary skill in the art would recognize many other variations, alternatives, and modifications. This work is normally performed at the system setup and configuration time.

Business constantly changes as a result of new products introductions, marketing campaigns, sales events, etc. As a result, Business Taxonomy needs to be updated to reflect current business state. The invention also includes a system for taxonomy maintenance. This system allows adding, deleting, splitting, merging, moving and modifying taxonomy nodes as well as updating training sets associated with each of the nodes. The System is developed to allow administrative users to adapt taxonomy to an ever-evolving business. Taxonomy Maintenance System detects when Taxonomy needs to be updated and provides tools to add/delete/update taxonomy branches as well as to re-build the Training Set associated with taxonomy nodes. FIG. 2E is a user interface of an application enabling taxonomy maintenance process. This figure is merely an example, which should not unduly limit the scope of the claims herein. One of ordinary skill in the art would recognize many other variations, alternatives, and modifications. As merely an example, the user interface includes a plurality of entries, which have a unique identification number 2081, free form text 2082, and reason code 2083, among other description information, as desirable. In a specific embodiment, the method decides how to associate each of the entries with a taxonomy node. Each taxonomy node includes a suitable number of entries to be able to describe the category. In a specific embodiment dealing with a frequent caller problem for a call center, each taxonomy node has 20 to 100 records, but is not limiting to such number of records. Further details of the present method and system are provided in more detail below.

Referring to FIG. 3A, the present embodiment of a system of the invention can be deployed on commercially available Microsoft Corporation Windows or Unix-based hardware. This diagram is merely an example, which should not unduly limit the scope of the claims herein. One of ordinary skill in the art would recognize many other variations, alternatives, and modifications. The following is a typical hardware configuration for an Action Center deployment. More powerful hardware would yield better performance of the system, but can also be replaced with others depending upon the embodiment.

1. Database Server: Pentium III 500 MHz, 2 CPU (4 CPU recommended) or equivalent UNIX system.

2. Text Classification Server: Pentium III 500 MHz, 2 CPU (4 CPU recommended) or equivalent UNIX system.

3. Data mining Server: Pentium III 500 MHz, 2 CPU (4 CPU recommended) or equivalent UNIX system.

4. Analytics Server: Pentium III 500 MHz, 2 CPU or equivalent UNIX system.

5. Application Server (Web Server): Pentium III 500 MHz, 2 CPU or equivalent UNIX system.

6. Client Workstation: Pentium III 500 MHz

The above embodiments describe aspects of the invention illustrated by elements in simplified system and/or software diagrams. As will be understood by one of ordinary skill in the art, the elements can be implemented in only computer software. The elements can also be implemented in computer hardware and software. Some of the elements may be integrated with other software and/or hardware, or specialized hardware (e.g. an ASIC). Alternatively, some of the elements may be combined together or even separated. It is also understood that the examples and embodiments described herein are for illustrative purposes only and that various modifications or changes in light thereof will be suggested to persons skilled in the art and are to be included within the spirit and purview of this application and scope of the appended claims.

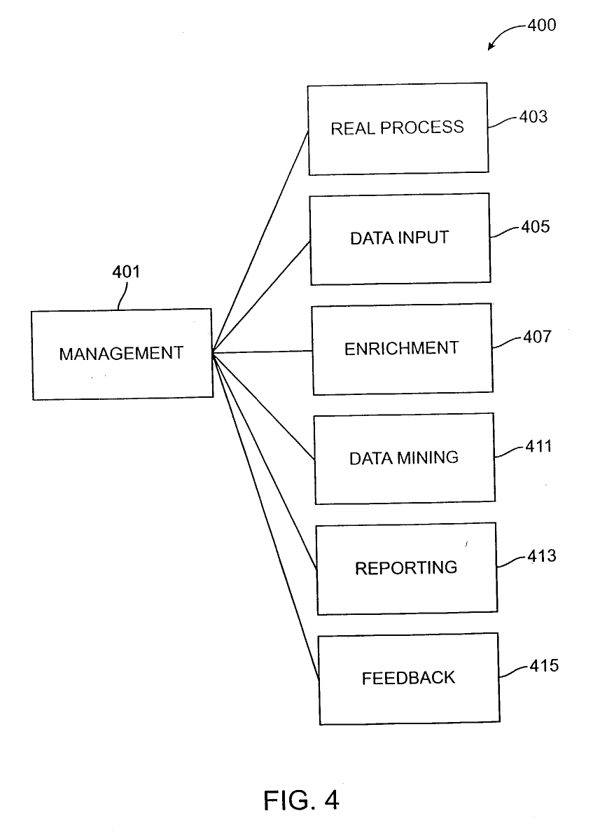

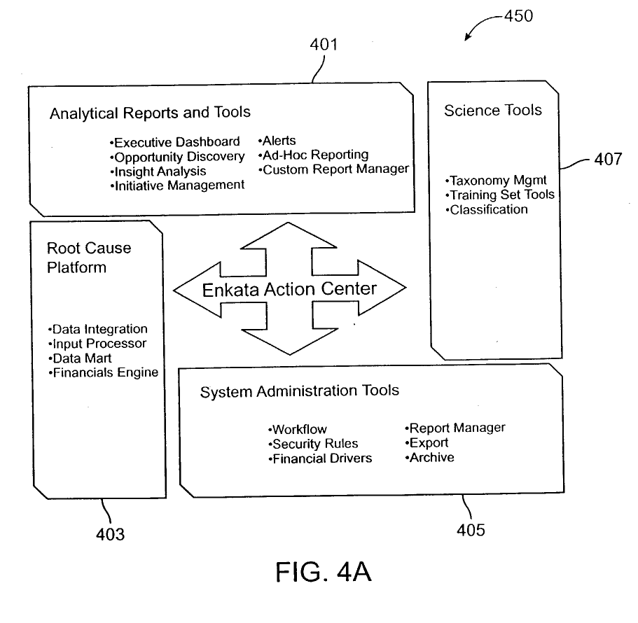

FIG. 4 is a diagram of system software 400 according to an embodiment of the present invention. This diagram is merely an example and should not unduly limit the scope of the claims herein. One of ordinary skill in the art would recognize many other variations, modifications, and alternatives. As shown, the software system 400 can represent the data analysis engine described above. The software system includes a variety of features such as a management module 401. The management module oversees the operation of other modules or processes. Here, the terms “module” and “process” are not intended to be limiting, but are merely used for illustration purposes.

As shown, the modules include a real process 403. The real process can include telephone call center service processes, sales and marketing processes, manufacturing processes, and any other processes required to support a business. The real process often has information that is derived from the process directly or indirectly. The information is provided into a data input process 405. The data input process is a handler for receiving data from the real process. Once the data are provided into the engine, the data are enriched through an enrichment process 407. Next, the data are mined through the text and data mining process 411. The system also includes reporting process 413 and feedback process 415. Depending upon the embodiment, details of each of these modules have been described throughout the present specification. Additionally, other modules can also exist depending upon the embodiment.

Referring to FIG. 4A according to a specific embodiment, the present system includes a plurality of building blocks, which can be implemented in customized software and/or hardware depending upon the application An example of such software and/or hardware is provided as follows:

Root Cause Analytics Platform, 403

Suite of sophisticated Science Tools tuned to discover root cause, 407

Suite of Root Cause Analytical Reports and Tools to guide customers to ‘million-dollar’ business improvement opportunities, 401

Suite of System Administration Tools to help customers tailor the application to their specific needs, 405

The above embodiments describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware, or specialized hardware (e.g. an ASIC). Alternatively, some of the elements may be combined together or even separated. It is also understood that the examples and embodiments described herein are for illustrative purposes only and that various modifications or changes in light thereof will be suggested to persons skilled in the art and are to be included within the spirit and purview of this application and scope of the appended claims. Further details of methods according to embodiments of the present invention are provided as follows.

A method according to an embodiment of the present invention may be provided as follows:

1. Provide data, including structured data in a first format and unstructured data in a first format, from a real process of a service or manufacturing operation;

2. Input the structured data and unstructured data into a processing engine;

3. Convert the unstructured data in the first format into a second structured format (optional);

4. Combine the structured data in first format and structured data in second format, which is now structured;

5. Store the structured data in the first format and the structured data in the second format in memory;

6. Process combined data with one or more business processes to couple the business process with the structured and unstructured data;

7. Process the combined data with one or more financial models to couple the financial process with the structure and unstructured data;

8. Identify one or more factors derived from the real process;

9. Determine one or more aggregate patterns coupled to the identified factors from the processed data;

10. Couple one of the one or more patterns to an economic value;

11. Display the factor and the pattern related to the factor and the economic value; and

12. Perform other steps as desired.

The above sequence of steps provides a way of processing structured and unstructured data for the purpose of identifying a pattern and associating such pattern to an economic value. The present steps provide an easier way of improving a real process, including service or manufacturing, using data enrichment and mining techniques. Further details of the present method can be found throughout the present specification and more particularly below.

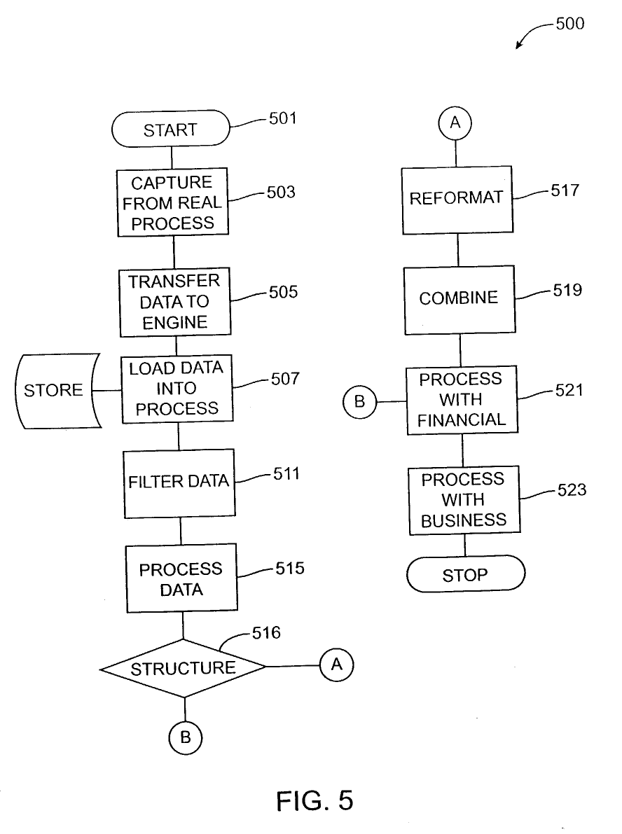

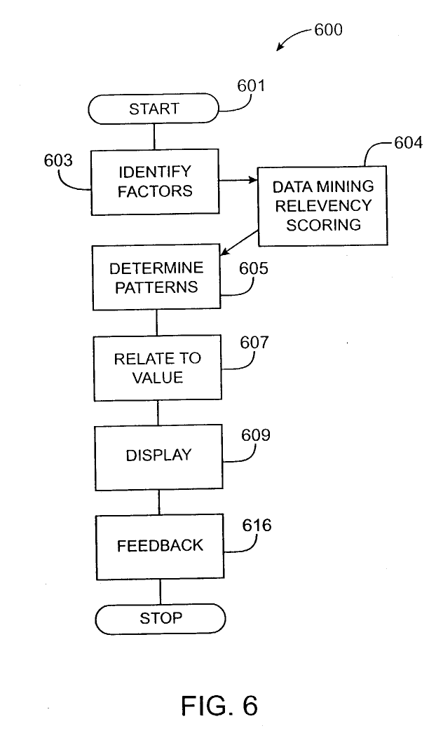

FIGS. 5 and 6 are simplified diagrams of methods 500, 600 according to embodiments of the present invention. These diagrams are merely examples and should not unduly limit the scope of the claims herein. One of ordinary skill in the art would recognize many other variations, modifications, and alternatives. As shown, the method 500 begins with start, step 501. The method captures information from a real process, step 503. Examples of such real process have been described. The information can be data that is structured and unstructured.

The data are extracted from a company's business management software, such as a customer relationship management product made by Siebel Systems, Inc. Alternatively, the management software can be from other sources including PeopleSoft, SAP, Peregrine Systems, Kana, and Epiphany. The data extracted are unstructured which has fields like call center agent notations. An example is provided below.

“Customer called because the new text messaging feature does not work and neither does his voicemail. He has a Nokia 5160 phone.”

The data extracted also include fields like product, names, customer types, call time, and problem types, which are structured. An example of structured data is provided below.

| | | | | MINUTES | |
|---|---|---|---|---|---|
| RECORD ID | PRODUCT | CUSTOMER | REASON CODE | ON CALL | SOURCE |
| 1 | Nokia 5160 | 13592 | 01—Billing | 15 | Western |
| | | | | | Region |

The data are transferred to a processing engine, step 505. Here, the data are often loaded into the process, step 507. Preferably, data are also stored, as shown. In a specific embodiment, data are filtered. Here, examples of filters would include removing special characters, merging several fields into one, splitting fields, computing duration based on start and end time stamps, etc. Of course, the type of filters used depends upon the application.

The data are processed, step 515. Here, data are separated by type, which includes unstructured data from the structured data. If there are only structured data, the method goes to step 521 via reference letter “B” according to a specific embodiment. According to an alternative specific embodiment, structured data are used in classification as well as other steps. Alternatively, if there are structured and unstructured data, the unstructured data are converted into a second structured format (optional), step 517. Here, the fields pertaining to ones such as call agent notations get converted into one or more “core concepts.” An example is provided below.

For a health insurance company, an HMO member may call about the status of a referral to a specialist. The agent may record in their notations that the caller was calling about “non-required referral ” and that the caller was calling about a referral to an “OB/GYN” specialist. These 2 concepts would be extracted from the notations and the data would be tagged as such.

The method then combines (step 519) the structured data in first format and structured data in second format, which is now structured. In particular, the newly tagged unstructured data are then recombined with the structured data. Next, the method processes the combined data with one or more business processes (step 523) to couple the business process with the structured and unstructured data. Here, certain fields are further tagged with information tying data to specific business processes. An example is provided as follows.

“Non-required referral” is tagged with “support of existing customer. ”

The method also processes the combined data with one or more financial models to couple the financial process with the structure and unstructured data, step 521. Here, the combined data is then associated with financials. An example is provided as follows.

Call time is multiplied by a cost per minute, which then tags that call time with an associated cost. Total cost per call is a sum of the handling time, costs assigned to the associated indicators and resolution cost. Allocated costs are computed for each indicator based on the total cost per interaction and confidences produced by the classification engine. Resolution cost includes any fee refunds, cost of customer churn as a result of the call, etc. and may be offset by the up sell opportunity if customer bought products or services as a result of the call.

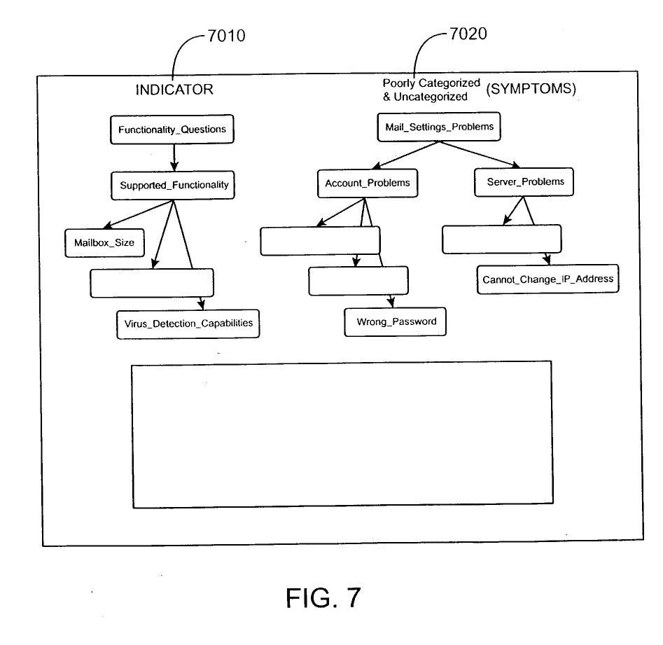

Once the combined data have been processed, the data are enriched. An example of such enriched data are provided by a simplified diagram of FIG. 7. This diagram is merely an example, which should not unduly limit the scope of the claims herein. One of ordinary skill in the art would recognize many other variations, alternatives, and modifications. As shown, the enriched data 7020 include indicator 7010 and poorly categorized and uncategorized data—i.e., symptoms 7020. Preferably, the diagram includes additional taxonomy nodes as the data become more enriched. The Supported Functionality, Account Problems and Server Problems categories of the taxonomy were enriched by adding an additional level of details derived from processing unstructured data. as shown. Examples of category names are also included, as shown and are provided below.

Category names:

Indicator!Functionality_Questions!Supported_Functionality!Mailbox_Size

Indicator!Functionality_Questions!Supported_Functionality!Accepts_Attachm ents

Indicator!Functionality_Questions!Supported_Functionality!Virus_Detection_Capabilities

Symptom!Mail_Settings_Problems!Account_Problems!Wrong_Email_Address

Symptom!Mail_Settings_Problems!Account_Problems!Wrong_Username

Symptom!Mail_Settings_Problems!Account_Problems!Wrong Password

Symptom!Mail_Settings_Problems!Server_Problems!Incorrect_Server_Name

Symptom!Mail_Settings_Problems!Server_Problems!Cannot_Change_IP_Address

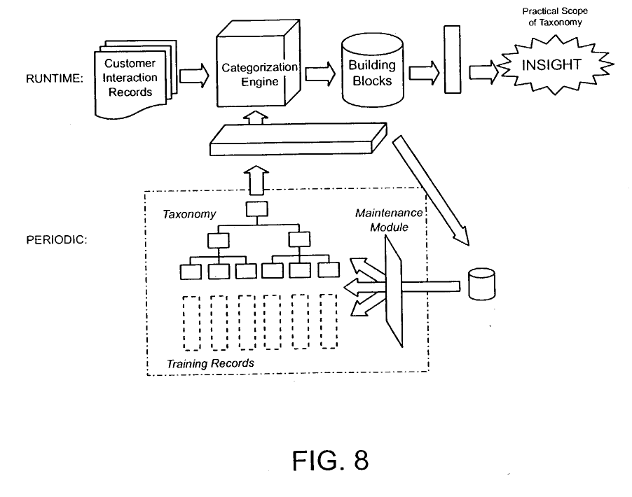

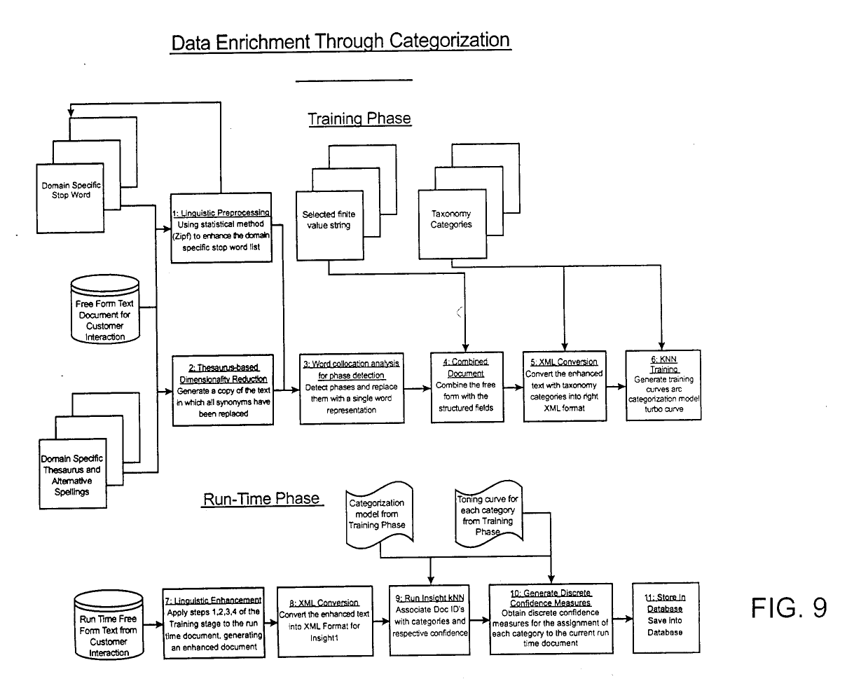

Referring to FIG. 8, a Classification process is deployed to enrich the dataset by processing unstructured data. This diagram is merely an example, which should not unduly limit the scope of the claims herein. One of ordinary skill in the art would recognize many other variations, alternatives, and modifications. The data enrichment thought text categorization process includes two phases depicted on the diagram illustrated in FIG. 9. The Training phase is responsible for the training set creation and classification models tuning. The Run-time phase is responsible for associating of the unstructured data with nodes of the taxonomy. This association is described by the confidence level assigned during classification process. The Run-time phase input is the taxonomy, training set and unstructured data. The Run-time phase output is confidence of the association between taxonomy nodes and records to be classified. The confidence represents degree of similarity between the training set records and record to be classified. Each record is classified to one or more nodes of the taxonomy. The method then stores the enriched structured data in the first format and the structured data in the second format in memory.

Further details of the present method are provided below.

Additionally, the above sequence of steps is performed using a combination of hardware and software. These steps can be further combined or even separated in computer software. Additionally, these steps can be further combined or even separated in computer hardware. The steps can also be combined with any combination of hardware and/or software, depending upon the embodiment. Accordingly, the present method is not intended to be limiting with respect to the type of technology that is presently available.

The method continues via the simplified flow diagram 600 of FIG. 6. Here, the method begins at start, step 601. The method identifies one or more factors derived from the real process, where the data originated. The factors can include Symptom, Situation profile, and Outcome. Here, certain analytics (such as Data mining-based correlations analysis, relative scoring models and statistics) are then run against the data set. The results are then inserted into memory. The method determines one or more aggregate patterns (step 605) coupled to the identified factors from the processed data. Here, additional analytics are run to identify patterns. An example is provided below.

“Non-required referral” calls are discovered to be highly correlated with the HMO product and with referrals to OB/GYN specialists.

The patterns are then coupled to an economic value, step 607. Here, the pattern is then reported with an overall economic value. An example is provided below.

“Non-required referral” calls about OB/GYN specialists from HMO member costs the company $X million per year in costs. A breakdown of different cost types such as Handling, Resolution, Outcome costs are also provided in the report.

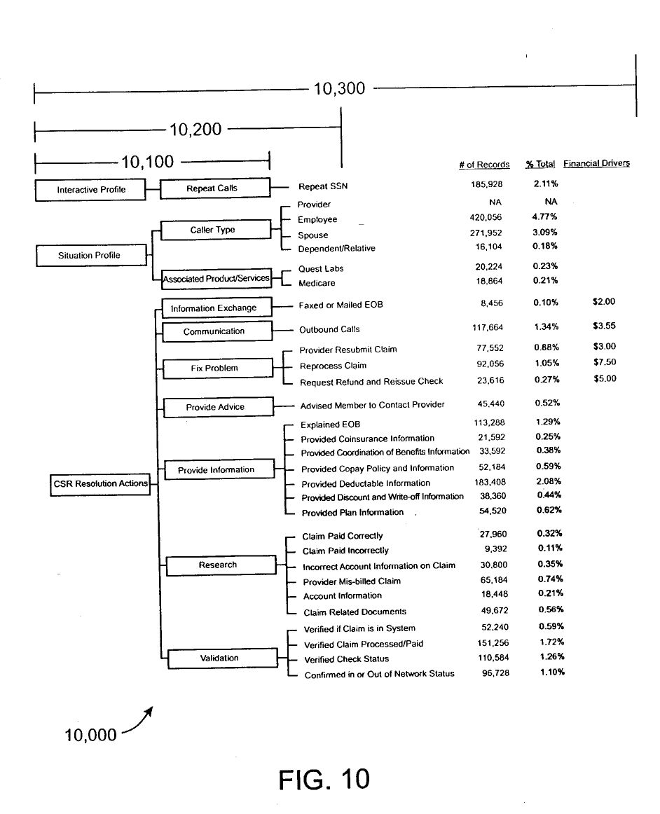

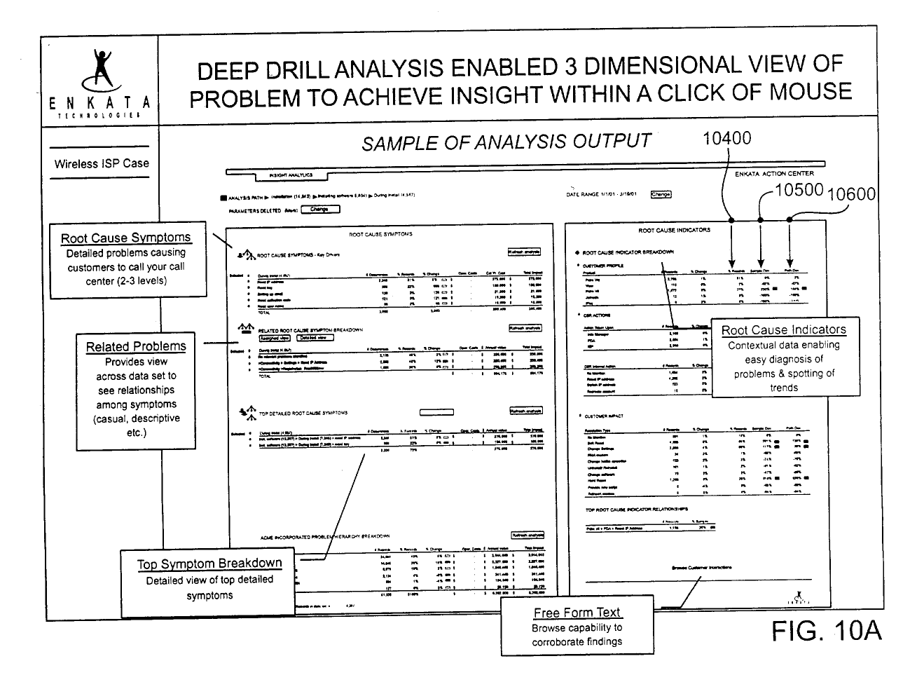

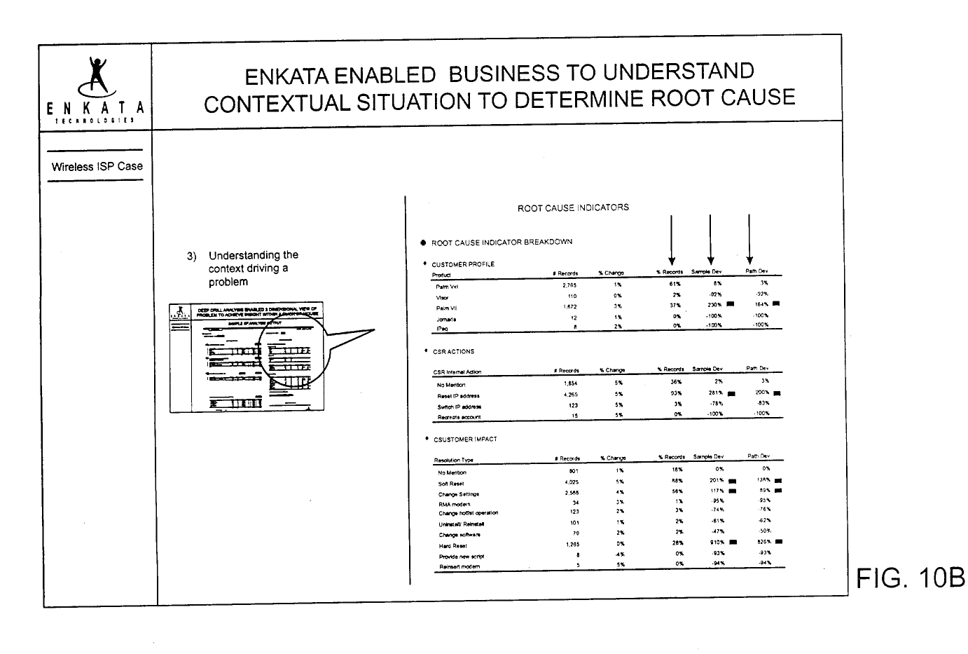

Next, the method displays the factor and the pattern related to the factor and the economic value derived using activity-based costing method (step 609). An example is provided by way of FIG. 10. The “Blue boxes” represent the original information. All other information was derived via the data enrichment process. As shown, taxonomy including statistics 10000 includes taxonomy 10100, taxonomy including enrichment 10200, and taxonomy including enrichment and statistical information 10300. Such statistical information may include number of records, percentage of records, financial drivers, among other information. Dependent upon the embodiment, there can be feedback (step 616) given to the real process to improve it. The method performs other steps, as desired. Additionally, the above sequence of steps is performed using a combination of hardware and software. These steps can be further combined or even separated in computer software. Additionally, these steps can be further combined or even separated in computer hardware. The steps can also be combined with any combination of hardware and/or software, depending upon the embodiment. Accordingly, the present method is not intended to be limiting with respect to the type of technology that is presently available.

FIG. 10A is a more detailed representation of Analytical Output. The application includes multiple calculations for each indicator allowing identifying which indicators are most representative of a root-cause for a given symptom. This diagram is merely an example, which should not unduly limit the scope of the claims herein. One of ordinary skill in the art would recognize many other variations, alternatives, and modifications.

% Interaction Records 10400: Given X interaction records for which the selected symptom(s) are present, some value Y interaction records (equal to or less than X) will also include the selected indicator. % Interaction records is equal to Y/X*100. For example, if there are 30,000 interaction records for symptom Verify Status, and 15,000 of those interaction records included the indicator PlanType=PPO, then the % Interaction Records for Verify Status containing PlanType=PPO is equal to 50%

% Sample Deviation 10500: This is a measure of how “different” the “% Interaction records” value is from the overall behavior of all analyzed interaction records, where “% Overall”=(All Interactions with Indicator/All Interactions). In order to calculate the % Sample Deviation we take: (% Interactions/% Overall)*100−100%. For example, if there are a total of 500,000 interaction records, and 100,000 (or 20%) of those interaction records include the indicator PlanType=PPO, then the sample deviation for plan type is equal to (50/20)*100% −100%, or 150%. This can be interpreted to mean that the PlanType=PPO indicator is 150% more likely to appear in interaction records where the symptom=Verify Status vs. a randomly selected interaction.

% Path Deviation 10600: This is a measure of how “different” the “% Interaction records” value is from the behavior of all interaction records that are included within the selected Symptom's parent node, where “% Path”=(Same Parent Interaction records with Indicator/All Interaction records with Same Parent). In order to calculate the % Path Deviation we take: (% Interaction records/% Path)* 100−100%. For example, if there are a total of 100,000 interaction records of Parent Node=Claims (the parent of Verify Status), and 40,000 (or 40%) of those interactions include the indicator PlanType=PPO, then the path deviation for plan type is equal to (50%/40%)*100−100%, or 25%. This can be interpreted to mean that the PlanType=PPO indicator is 25% more likely to appear in interactions where the symptom=Verify Status vs. any randomly selected interaction within the Parent Node of Claims.

In order to make it easier for end-users to quickly identify which indicators may have useful predictive value the application computes relevance scores for all indicators and highlights potentially important indicators. The relevance scores are weighted combination of % Interactions, % Sample Deviation, and % Path Deviation. The following calculations are performed to produce the relevance scores:

(% Interaction records)*(Weight 1)+(Absolute value of % Sample Deviation)*(Weight 2)+(Absolute value of % Path Deviation)*(Weight 3), where Weights 1, 2, and 3 are user-configurable values to indicate relevant importance of % Interaction records, % Sample Deviation, and % Path Deviation components. A normalized relevance score is computed by applying a logarithmic function to the score calculated using the formula above. The final relevancy score is computed as follows: [(un-normalized relevance score for indicator)−(minimum un-normalized relevance score for all indicators)]/[(maximum un-normalized relevance score for all indicators)−(minimum un-normalized relevance score for all indicators)]. The application allows to quickly identification of potential key indicators that may be contributing to the symptom(s) by examining numerical or graphical representation of the normalized relevance scores. The above embodiments describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware, or specialized hardware (e.g. an ASIC). Alternatively, some of the elements may be combined together or even separated. It is also understood that the examples and embodiments described herein are for illustrative purposes only and that various modifications or changes in light thereof will be suggested to persons skilled in the art and are to be included within the spirit and purview of this application and scope of the appended claims.

### EXAMPLES

To prove the principles and operation of the present invention, we have implemented aspects of the invention in the following examples. These examples are merely illustrations and should not unduly limit the scope of the claims herein. One of ordinary skill in the art would recognize many other variations, modifications, and alternatives.

Finding Opportunity Through Trends:

1) Click on “Opportunity Dashboard” in the Manager's report section;

2) Click on the handling cost trend line in the “COSTS” chart. A pop-up menu should show up;

3) Click on “Drill to Next Level”;

4) Repeat by clicking on the trend line that as a box around the CAGR and keep drilling down until you reach lowest level;

5) At lowest level, “Voicemail issues” or at any level, you can click on the “One-Click Insight” selection on the pop-up menu. This brings you to the One-Click Insight Page (a.k.a. Insight Explorer);

6) Click on browse interactions to see text of the free form text interaction; The system also allows to play voice recording of customer interaction associated with the call.

Finding Opportunity Through the Top 10:

1) Click on “Opportunity Dashboard” in the Manager's report section;

2) Select one of the precomputed analysis links;

3) Scroll down to top opportunities list (e.g., top ten);

4) Click on “Cannot Access Voicemail” link in first row of table. This brings you to the One-Click Insight Page (a.k.a. Insight Explorer);

5) Click on browse interactions to see text of the free form text interaction; The system also allows playing voice recording of customer interaction associated with the call.

Additionally, the above sequence of steps is performed using a combination of hardware and software. These steps can be further combined or even separated in computer software. Additionally, these steps can be further combined or even separated in computer hardware. The steps can also be combined with any combination of hardware and/or software, depending upon the embodiment. Accordingly, the present method is not intended to be limiting with respect to the type of technology that is presently available. Furthermore, the present invention also includes an activities tracking system, which will be described in more detail below.

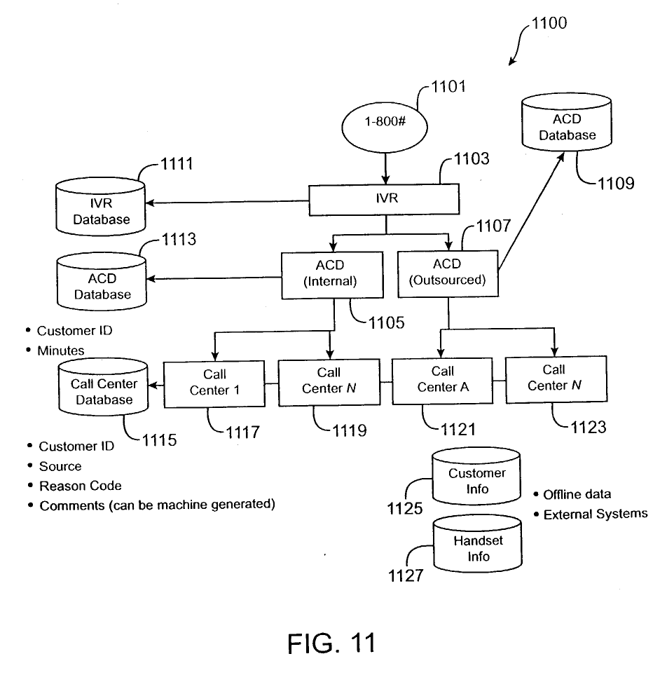

FIG. 11 is a simplified diagram of an activities tracking system 1100 according to an embodiment of the present invention. This diagram is merely an example and should not unduly limit the scope of the claims herein. One of ordinary skill in the art would recognize many other variations, modifications, and alternatives. As shown, the system 1100 includes a variety of systems/features such as call centers 1117, 1119, 1121, 1123. An Interactive Voice Response System 1103 is also included. The Interactive Voice Response System includes database 1111. The Voice Response System is coupled to Automated Call Dispatch systems, which include internal 1105 and outsourced 1107. An Automated Call Dispatch database 1109 coupled to the outsourced Automated Call system is also included. An Automated Call Dispatch database 1113 coupled to internal Automated Call Dispatch system 1105 is also included. Each of the call centers can also include database 1115. Preferably, the system also includes an Interaction Unit Creation. The Interaction Unit is a logical unification of the information related to a single customer contact (ex. call to a contact center). A call 1101 is received by the Interactive Voice Response System. As the call traverses through more than one call center or other system customer information 1125 is stored in one or more databases. Further details of the present system are described below.

In other embodiments such as many large companies (e.g., Fortune 500 companies), complex operational environments in their contact centers are included. Such environment includes elements such as the Automated Call Distributor (ACD) Systems, Interactive Voice Response (IVR) Systems, Legacy Systems that include mainframe platforms, client server products made by companies like Siebel, Oracle, PeopleSoft, SAP, home-grown applications, etc. Each of the systems captures certain activities representing partial information about customer contact. Preferably, in order to derive root causes of customer interactions, it is desirable to be able to combine two or more or all activities related to a complete customer contact into a logical interaction unit. In conventional systems, it is difficult since activities related to a single logical interaction are created by systems that often “do not talk” to each other and have either no “keys” to link the data or the “keys” information is not complete.

Accordingly, the present invention includes an “Interaction Unit,” which combines information from each of the systems for tracking activities. The Interaction Unit also may have parts residing in different time zones. Such Interaction Unit includes features for matching time zones between account remarks and Automated Call Dispatch (ACD) records. Dates may need to have hours subtracted or added to match records in the absence of a key field to link the different systems. Daylight savings can also be coded as well in certain embodiments. The Interaction Unit derives relationships between various systems representing the sources of customer activities. Such relationships are derived by performing transformations on data derived from individual systems and then joining the resulting data to produce the Interaction Unit. During this process one of the source systems is selected as a “driver” for the interaction unit creation and the rest of the systems are being “joined” to it by virtue of the derived “keys”.

As merely an example, the Automated Call Dispatch (ACD) system may be selected as a driver for Interaction Unit Creation. Examples of transformations leading to Interaction Unit creation are: Grouping ACD activities representative of the same Interaction; Activity Customer Identification from the ACD data; Activity Customer Identification from Account Remarks data; Identifying the Agent-handled Interactions; Identifying Customers from the ACD data; Matching Account Remarks and ACD data. Preferably, the accuracy of the Interaction Unit creation determines the accuracy of the root cause identification. It may also determine the correct Number of Customer Interactions as well as impacts the accuracy of Financial Allocations and Co-occurrences of Symptoms and Indicators.

In a specific embodiment, a number of Interaction Unit Transformation methods can be used to produce the Interaction Unit. In certain cases, such transformations are heuristic-based. For example, to identify a customer in the ACD data and associate that Customer with the information collected by the ACD system, a transformation may utilize customer account identification number and/or identification number of the customer service agent who handled the call in conjunction with a specified time interval used to separate multiple calls handled by the customer service agent. Not all customers, however, can be identified this way during an interaction. Interactions from customers that cannot be identified using this method can be allocated proportionally to the statistics observed in a well-identified sample. Depending upon the embodiment, there can be many other variations, modifications, and alternatives.

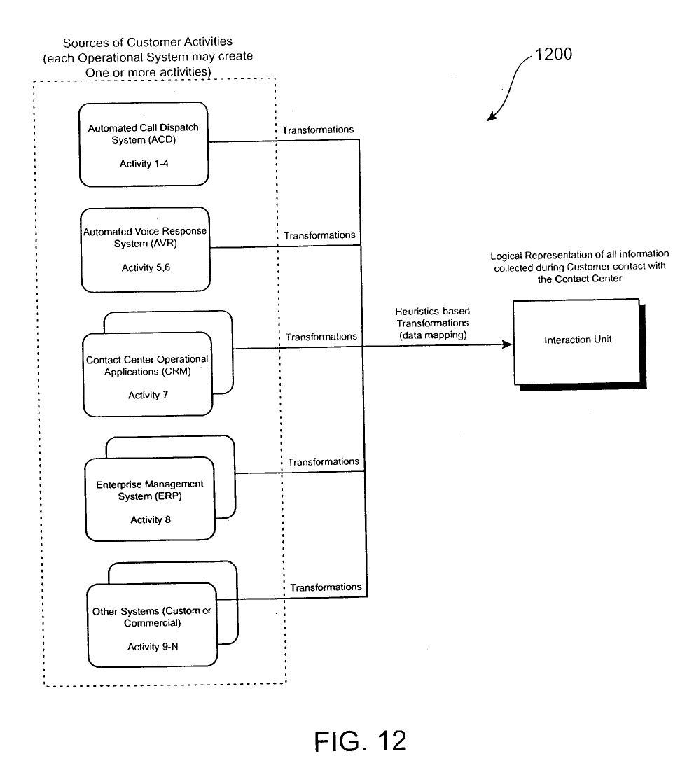

FIG. 12 is a more detailed diagram of an activities tracking system 1200 including an interaction unit according to an embodiment of the present invention. This diagram is merely an example and should not unduly limit the scope of the claims herein. One of ordinary skill in the art would recognize many other variations, modifications, and alternatives. As shown, the call goes through more than one system. As merely an example, the call goes through the Automated Call Dispatch System (ACD) and performs activities 1-4. Next the call goes through the Automated Voice Response System (AVR), which includes activities 5 and 6. The call then goes through the Contact Center Operational Applications (CRM)—activity 7. Thereafter, the call goes through the Enterprise Management System (ERP) (activity 8), and other systems custom or commercial, activities 9 through N. Depending upon the specific format of information used in any of the systems, there may be transformations of the information into a common format, which can be Heuristics-based Transformations. The Interaction Unit receives information from each of the activities according to a preferred embodiment.

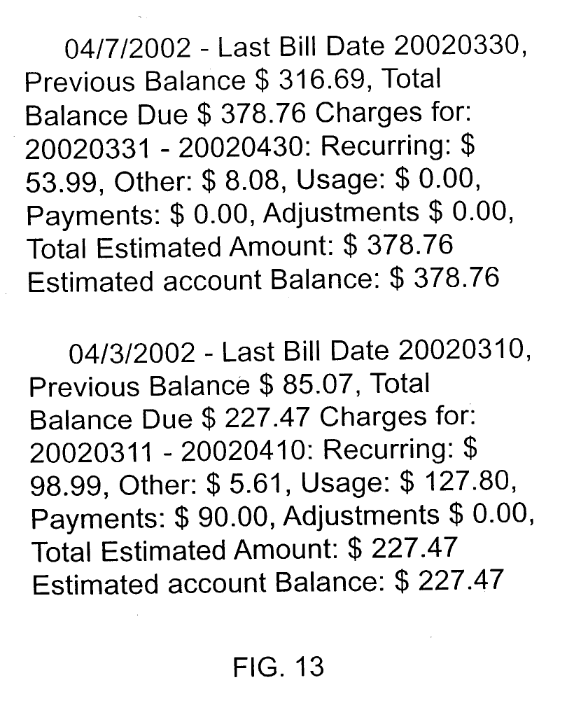

FIG. 13 are examples of templates-based text (“Templates”) according to embodiments of the present invention. Templates represent concatenations of structured data fields in order to produce a single data string that can be stored as text data in memory. Templates are often used for systems to communicate with each other. This communication is expressed in a form of one system inserting templates-based text into the database of the other system. This diagram is merely an example and should not unduly limit the scope of the claims herein. One of ordinary skill in the art would recognize many other variations, modifications, and alternatives.

□ Apr. 7, 2002—Last Bill Date Mar. 30, 2002, Previous Balance $316.69, Total Balance Due $378.76 Charges for: Mar. 31, 2002-Apr. 30, 2002: Recurring: $53.99, Other: $8.08, Usage: $0.00, Payments: $0.00, Adjustments $0.00, Total Estimated Amount: $378.76 Estimated account Balance: $ 378.76

□ Apr. 3, 2002 —Last Bill Date Mar. 10, 2002, Previous Balance $85.07, Total Balance Due $227.47 Charges for: Mar. 11, 2002-Apr. 10, 2002: Recurring: $98.99, Other: $5.61, Usage: $127.80, Payments: $90.00, Adjustments $0.00, Total Estimated Amount: $227.47 Estimated account Balance: $ 227.47

Template definitions can be derived from the client in a form of documentation or electronic file of known templates. Templates are defined in, for example, Enkata's system using “regular expressions” syntax. A rules engine is used to match text to the template definitions. Once Template is detected by the Rules Engine, it's being classified and processed. The Rules Engine also executes rules that may be associated with the Template. The Template rules allow:

1. Map Template to Symptom and/or Indicator(s) represented as Taxonomy nodes

2. Split Templates into a collection of the structured fields for future processing by the analytical engine

3. Trigger execution of the transformations on the data.

As shown, each of the templates (e.g., beginning at Apr. 7, 2002, beginning Apr. 3, 2002) has a string of information. Each of the original fields is separated from another field using a comma “,”, but can be another form of regular expression including rules or logical rules depending upon the application.

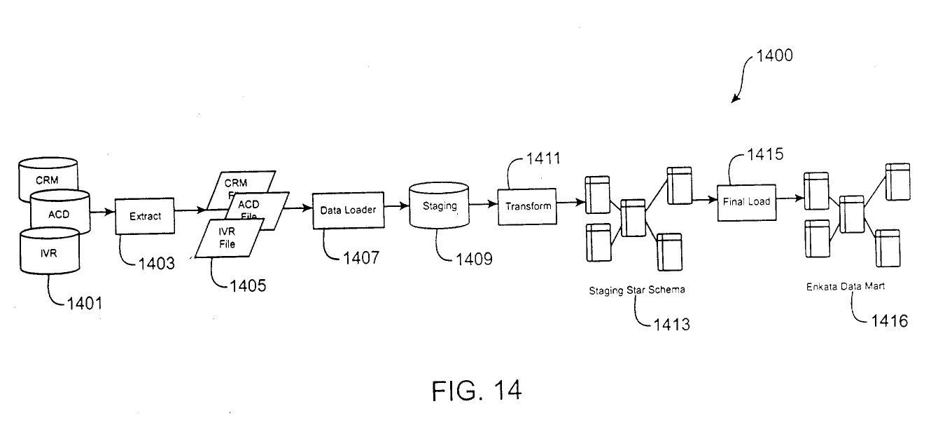

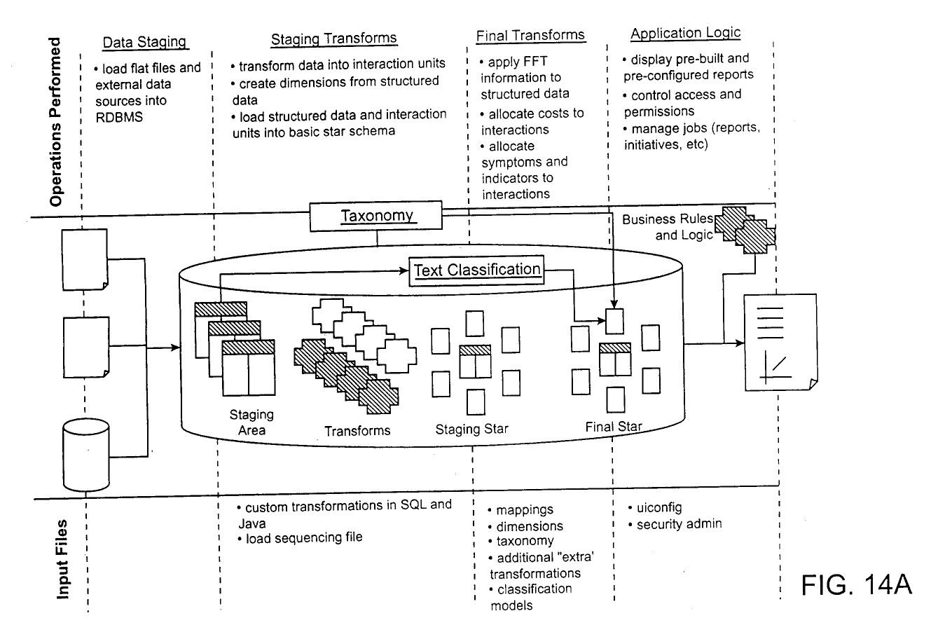

FIG. 14 is a detailed diagram of a data load process 1400 according to an embodiment of the present invention. This diagram is merely an example and should not unduly limit the scope of the claims herein. One of ordinary skill in the art would recognize many other variations, modifications, and alternatives. In a specific embodiment, the process can be managed by an executable script, such as DOS Batch File or UNIX Shell Script, but may be others. The process also includes user interface to control and monitor the execution according to certain embodiments. As shown, the process includes deriving information from more than one information source, such as CRM, ACD, or IVR systems 1401, as well as others. Selected information, which includes caller information and contextual information for the call, is extracted 1403 into data files.. Each of the systems sends a corresponding file 1405 to a data loader 1407, which performs a load process. Depending upon the embodiment, there can be more than one way to load the information.

In a specific embodiment, the process can include explicit-sequencing, which is commonly used. The process defines a load as a sequential process, broken up into phases which are in turn divided into steps. A phase is a major unit of processing; it represents a section of the data load, such as extracting customer-provided data from text files, transforming data (step 1411), or loading the final star schema (step 1413). A step is a minor unit of processing and always occurs within a phase. Steps include actions such as loading a file, executing a SQL script, or invoking text classification. Phases that are independent of each other may also be defined to run in parallel. A more detailed diagram of staging and transform is illustrated by way of FIG. 14A.

According to an alternative embodiment, the process can include block-sequencing. Such process defines data load as a series of autonomous units known as blocks. Each block is a minor unit of processing, much like a step. Blocks are also, however, aware of their dependencies; the tables they rely on and the tables they create. When running a load, the loader will automatically sequence blocks according to their dependencies. Blocks may be organized into modules, which may act like directories for blocks. Such organization has no effect on dependencies and sequencing, however.

A method according to an embodiment of the present invention for block sequencing is as follows:

1. Provide data with input tables;

2. Sequence transformations, which are dependent;

3. Output data to output tables; and

4. Perform other steps, as desired.

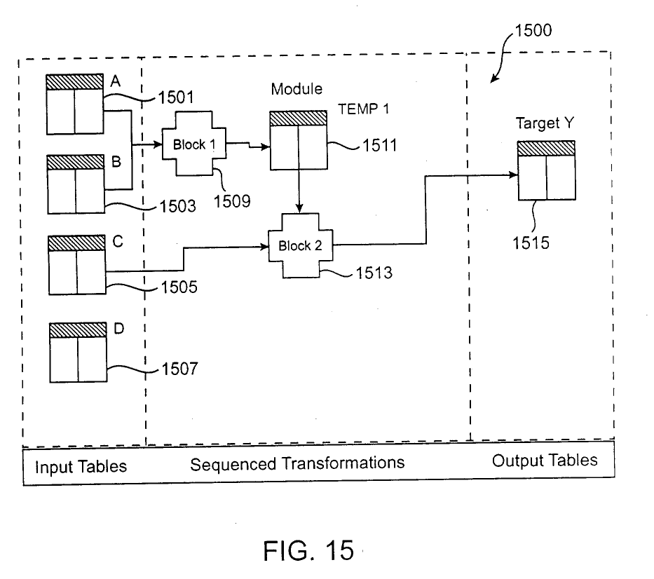

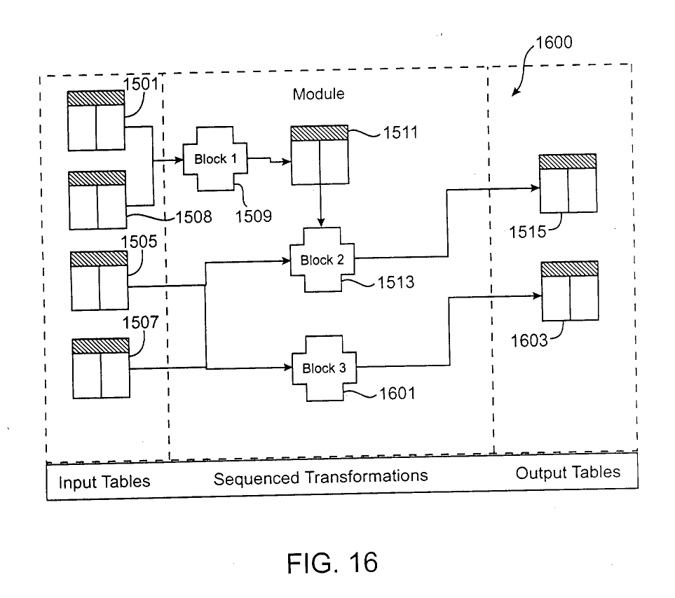

The above steps are used to provide a general way of loading data into a transformation process. The transformation process may be dependent, such as the one illustrated in the simplified diagram of FIG. 15. The process includes providing data in tables, 1501, 1503, 1505, and 1507. As merely an example, the data in tables are provided from a staging process, as previously noted. The process transfers data from Table A 1501 and Table B 1503 to Block 1 1509. The process outputs from Block 1 to Temp 1 1511. The block includes one or more operations or steps that transform data from one or more Input Tables into one or more Output Tables. Block 2 1513 includes Table C 1505, Table D 1507 and Temp 1 1511 as inputs for Block 2. An output for Block 2 is Target Y 1515. As shown, Block 1 and Block 2 form a logical grouping, which defines a module, according to an embodiment of the present invention. As shown, Block 2 is receives information from Temp 1 and is dependent upon Temp 1 such that Block 2 will not execute until Block 1 has completed is process. Preferably, the Block 1 process has been a successfully process. Alternative embodiments of the block process are provided below. FIG. 16 is a simplified diagram of a parallel block execution process 1600 according to an embodiment of the present invention. This diagram is merely an example, which should not unduly limit the scope of the claims herein. One of ordinary skill in the art would recognize many other variations, modifications, and alternatives. Like reference numerals are used in this diagram as certain others, but are not intended to be limiting. As shown, Block 3 1601 has been added into the module, which includes Block 1 1509 and Block 2 1513, which have been previously described. Block 3 receives data from Table C 1505 and Table D 1507. Block 3 does not receive input from either Block 1 or Block 2 and does not receive input from both Block 1 and Block 2. Accordingly, the process executes Block 3 in parallel to the process of Blocks 1 and 2 in a specific embodiment. The process includes transferring data from Table C and D into Block C. Preferably, only Table C is shared with Block 2 and Block 3. In a specific embodiment, the process only allows the Table to be accessed by only one Block. When Block 2 is accessing Table C, Table C is locked from Block 3. Alternatively, when Block 3 is accessing Table C, Table C is locked from Block 2. Here, Block 2 waits before accessing Table C, while Table C is being used by Block 3.

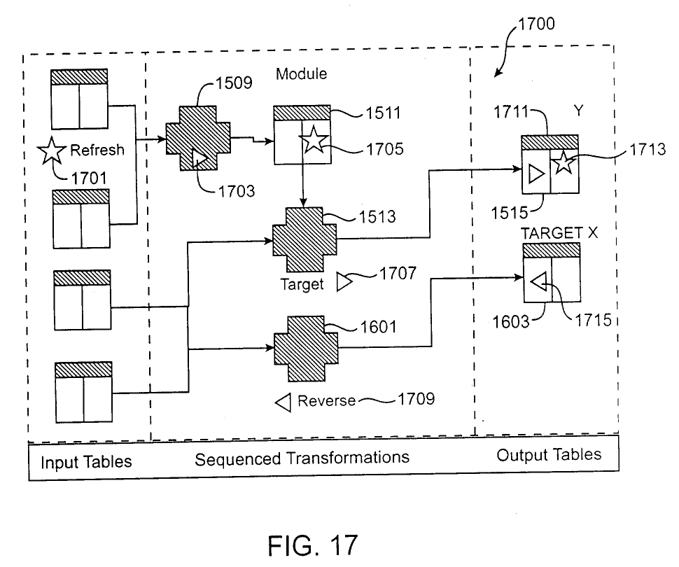

Preferably, the method is also bi-directional. That is, loads may be run forward (typically transforming and populating data) or backward (typically removing data and cleaning up temporary tables). Backward runs are particularly useful when developing a data load or recovering from errors. Loads using steps rely on the steps themselves defining appropriate actions for backward execution. Loads using blocks use dependency information to automatically run backwards. FIG. 17 is a simplified diagram of a block and table process according to an embodiment of the present invention. As shown, like reference numerals are used in this diagram as certain others, but are not intended to limit the scope of the claims herein. The block and table process includes a table refresh 1701. Preferably, any input table called by the module can be refreshed. The refresh is indicated to the data load process that data in a certain input table has changed. When an input Table is refreshed, any and all dependent tables are blacklisted, that is, flagged as desiring updating a next time when a dependent Block is Targeted. As shown, Table A has been flagged as being refreshed 1705. Dependent tables (Temp 1 and Target Y) are blacklisted, which indicates that content in Temp 1 and Target Y are not reliable. Block 2 is now targeted 1707. Before Block 2 executes, Block 1 will be executed and Temp 1 updated with refreshed data. The method had determined that the data in Temp 1 are blacklisted.

The method also includes a reverse command 1709. The method deletes data 1603 in Target X 1715. Block 3 controls removal of data from the Target. Depending upon the embodiment, there can also be other steps, which are added or inserted into any of the above.

The data load can be scheduled to run at predefined times or periodically. A scheduler wakes up and executes the load script to start the data load.In a specific embodiment, the method also includes a data load control file. As merely an example, we refer to this sample implementation of load.xml. This example includes load elements: steps, phases, blocks, and modules:

<load>

<phase name=“EXTRACT”>

<sqxml name=“PREPARE” file=“prepare.sqx” />
<load-files name=“BULKLOAD” descriptor=“stage.xml”

location=“mydata.zip” />

</phase>
<module name=“TRANSFORM”>

<block name=“DIMENSIONS”>

<input table=“S_USER” />
<input table=“S_PRODUCT” />
<input table=“S_PROMOTION” />
<output table=“SF_CUSTOMER” />
<output table=“SF_PRODUCT” />
<output table=“SF_CAMPAIGN” />
<temp table=“TT_CUSTOMER_TYPES” />
<sql name=“DIMENSIONS” file=“dimensions.sql” />

</block>
<block name=“FACTS”>

<input table=“S_SALES” />
<input table=“S_RETURNS” />
<output table=“SF_BUY” />
<output table=“SF_RETURN” />
<sql name=“FACTS” file=“facts.sql” />

</block>

</module>
<module name=“LOAD”>

<sqxml-module name=“DIMENSIONS” file=“schema.xml”

xsl=“load_dimensions.xsl” />

<sqxml-module name=“FACTS” file=“schema.xml” xsl=“load_facts.xsl” />

</module>

</load>

Additionally, the above sequence of steps is performed using a combination of hardware and software. These steps can be further combined or even separated in computer software. Additionally, these steps can be further combined or even separated in computer hardware. The steps can also be combined with any combination of hardware and/or software, depending upon the embodiment. Accordingly, the present method is not intended to be limiting with respect to the type of technology that is presently available.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method of processing information for root cause analysis, including structured data and unstructured data, the method comprising:
inputting structured data in a first format and unstructured data in a first format from a real process from a service or manufacturing operation;
converting the unstructured data in the first format into a second structured format;
collecting the structured data in first format and structured data in second format;
storing the structured data in the first format and the structured data in the second format into memory;
processing information from collected data with one or more business processes to couple the business process with the structured and unstructured data;
processing information from the collected data with one or more financial models to couple the financial process with the structured and unstructured data;
processing information from the collected data with one or more relevancy scoring models to couple the root-cause relevancy information with the structured and unstructured data.
identifying one or more factors derived from the real process;
determining one or more aggregate patterns coupled to the identified factors from the processed data;
coupling one of the patterns an economic value; and
displaying the factor and the pattern related to the factor and the economic value.

2. The method of claim 1 wherein the one or more business processes is selected from a customer life cycle, and a company organization.

3. The method of claim 1 wherein financial module is selected from a revenue model, and a cost model.

4. The method of claim 1 wherein the factor is selected from a symptom and an indicator.

5. The method of claim 1 wherein the indicator is a return.

6. The method of claim 1 wherein the factor is a field in the database.

7. The method of claim 1 wherein the structured data are in a predetermined format of a customer.

8. The method of claim 1 wherein the unstructured data are free from being provided into one or more structures.

9. The method of claim 1 wherein the displaying includes outputting.

10. The method of claim 1 wherein the unstructured data comprises electronic mail messages or information collected by a website.

11. A system including one or more memories, the one or more memories comprising:
a code directed to receiving structured data in a first format and unstructured data in a first format from a real process from a service or manufacturing operation;
a code directed to converting the unstructured data in the first format into a second structured format;
a code directed to collecting the structured data in first format and structured data in second format;
a code directed to storing the structured data in the first format and the structured data in the second format into memory;
one or more codes directed to processing information from collected data with one or more business processes to couple the business process with the structured and unstructured data;
one or more codes directed to processing information from the collected data with one or more financial models to couple the financial process with the structure and unstructured data;
a code directed to identifying one or more factors derived from the real process;
a code directed to determining one or more aggregate patterns coupled to the identified factors from the processed data;
a code directed to coupling one of the patterns an economic value; and
a code directed to displaying the factor and the pattern related to the factor and the economic value.

12. A method for tracking a call interaction through more than one activity through a contact center, the method comprising:
identifying a call from a caller at a selected process from a plurality of processes in a call center location;
forming an interaction record for the call and storing the interaction record in memory, the interaction record being directed to the call;
associating the interaction record with more than one activity through the call center;
transferring information from the association from more than one activity to the interaction record stored in memory;
receiving the information at an interaction unit; and
repeating the steps of identifying, forming, associating, transferring, and receiving for other calls numbered from 1 through N, where N is an integer greater than 1.

13. The method of claim 12 wherein the more than one activity is derived from more than one system, the system being selected from a billing system, a call tracking system, a voice response system, a call dispatch system, a home-grown system, and any other CRM or ERP system.

14. The method of claim 12 wherein memory is provided in a relational database.

15. The method of claim 12 further comprising [transferring from the system to a file and then processing the information for format]
